(19) United States
(12) Patent Application Publication
(10) Pub. No.: US 2004/0223181 A1
(43) Pub. Date: Nov. 11, 2004

(54) Control method relating to image formation and image formation method

(75) Inventor: Atsushi Narusawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/733,810

(22) Filed: Dec. 12, 2003

(30) Foreign Application Priority Data
Dec. 13, 2002 (JP) 2002-363069

(51) Int. Cl. G06F 9/28; G06F 3/12

(52) U.S. Cl. 358/1.15; 382/304

(57) ABSTRACT

When generating and printing an image based on a document written in XHTML or another structured tag language, the throughput of image generation and printing is improved. An apparatus of the present invention comprises judgment means for judging whether a document written in a structured tag language contains tags which can cause disagreement between the order in which the coordinate positions of objects are determined and the order in which object images are formed, and control means to perform control such that, when the above tags are judged to be contained, image formation processing is executed after processing to determine coordinate positions has ended, and when the above tags are judged not to be contained, processing to determine coordinate positions and processing to form images are executed in parallel.

### BACKGROUND

This invention relates to a technique for analyzing a document written using a structured tag language and generating an image.

When generating an image (for example, when printing) based on a document written in XHTML or another structured tag language, a methodology is adopted in which, first, the document is analyzed, objects comprised by the image (drawing elements: text, images, borders, and similar) to be printed are extracted (analysis task), then object layout is performed and the coordinate positions in the image are determined (layout task), and then printing is executed based on the coordinate positions of each object (printing task) (see for example Japanese Patent Laid-open No. 2002-91726).

### SUMMARY

In the prior art, printers supporting XHTML or similar have in some cases adopted a configuration in which, in the layout task, coordinate positions are passed to the printing task according to the order in which the coordinate positions of objects are determined.

However, the order in which the coordinate positions of objects are determined does not necessarily coincide with the order of printing of objects in the printing task; for example, when tags such as “position”, “margin”, “line-height”, and “img” exist, there may occur situations in which an object the coordinate position of which is determined later is printed earlier.

Hence in such cases the printing task must operate on the assumption that the order in which coordinate positions are acquired and the printing order do not coincide, and consequently the problem arises that the coordinate positions of all objects must be acquired before the object printing order can be determined. This means that if layout task processing is not completed the image generation and printing cannot be begun, that is, the layout task and the printing task cannot be executed in parallel, and this causes a large reduction in throughput for printing and other actions.

This problem of a reduction in the throughput of printing and other actions can also occur when there exist “counter” and other tags. When for example a document is configured so as to use a “counter”-type tag to display “(page number/total number of pages)” text, if the layout for the entire document is not determined and the total number of pages not confirmed, the contents of the “(page number/total number of pages)” text cannot be determined, and so the layout task and the printing task cannot be executed in parallel.

On the other hand, in printers of the prior art which support XHTML and similar, there are cases in which a configuration is adopted such that the coordinate positions of objects are passed to the printing task according to the order of registration (extraction order) of objects in the document.

However, the registration order (extraction order) of objects in a document does not necessarily coincide with the printing order of objects in the printing task; for example, when “position”, “margin”, “counter”, “line-height”, “img” and other tags exist, there may occur situations in which objects in the document which are registered later are printed earlier on the page.

Consequently in such cases also, similarly to the previous cases, there is the problem that if the coordinates of all the objects on a page have not been acquired, the order of printing of objects in page units cannot be determined. This means that if the coordinates of all the objects on each page are not acquired it is not possible to begin image generation or printing, and so this causes substantial reduction in the throughput of printing and other actions.

The present invention has as an object the resolution of such problems, and improvement of the throughput of printing and other actions.

In order to achieve this object, a control method relating to image formation of this invention comprises a step of judging whether a document written in a structured tag language comprises tags which may cause disagreement between the order in which coordinate positions of objects are determined and the order in which the image of the objects is formed, and a step, when the above tags are judged to be comprised, of executing processing to form the image after the end of processing to determine coordinate positions, and when the above tags are judged not to be comprised, of executing in parallel processing to determine coordinate positions and processing to form the image.

By means of this configuration, when a document comprises no tags which can cause disagreement, processing to determine coordinate positions and processing to form the image are performed in parallel, and the throughput of printing and other actions can be greatly improved.

Further, a control method relating to image formation of this invention comprises a step of judging whether a document written in a structured tag language comprises tags which may impede the parallel execution of processing to determine the coordinate positions of objects and of processing to form the image of the objects, and a step, when the above tags are judged to be comprised, of executing processing to form the image after the end of processing to determine coordinate positions, and when the above tags are judged not to be comprised, of executing in parallel processing to determine coordinate positions and processing to form the image.

By means of this configuration, when a document comprises no tags which can impede parallel operation, processing to determine coordinate positions and processing to form the image are performed in parallel, and the throughput of printing and other actions can be greatly improved.

It is preferable that the above judgment and the above control be performed for the entire document or for a portion thereof according to the types of the above tags. By means of this configuration, the possibility or impossibility of parallel operation can be judged for each prescribed range according to the tag type, so that processing can be switched more flexibly and precisely when performing operations.

It is preferable that the above tags comprise at least one among “position”-type tags, “margin”-type tags, “line_height”-type tags, “img”-type tags, and “counter”-type tags.

A layout processing method of this invention comprises a step of analyzing a document written in a structured tag language and extracting objects forming an image, a step of determining the coordinate position of each object in the image, and an object information output step of determining the order of arranging when each object is arranged in a prescribed direction, based on the coordinate position of each object, and of outputting information for each object, including coordinate positions, according to the above order.

By means of a layout processing method with this configuration, when an image is generated based on the results of layout processing output, it is possible to operate as though the content of the image is determined in the region up to the coordinate positions of received object information. As a result, it becomes possible to partially generate the image, starting with a region for which the image content is determined, without waiting for the information for all objects forming the image to be received; as a result, the throughput of image generation can be greatly improved.

An image formation method of this invention comprises a step of analyzing a document written in a structured tag language and extracting objects forming an image, a step of determining the coordinate position of each object in the image, an object information output step of determining the order of arranging when each object is arranged in a prescribed direction, based on the coordinate position of each object, and of outputting information for each object, including coordinate positions, according to the above order, and an image generation step of generating an image based on the object information output by the above object information output step; wherein in the above image generation step, a partial image is generated, in the order in which object information is received, for a region preceding in the above prescribed direction the coordinate positions included in the object information.

By means of this configuration, the image generation step can operate as though the content of the image is determined in the region up to the coordinate positions of the received object information. As a result, it becomes possible to partially generate the image starting with a region in which the image content is determined, without waiting to receive the information for all objects forming the image, so that the throughput for image generation can be greatly improved. Moreover, it becomes possible to manage the object information used in generation and the image in the units of partial generation, so that the efficiency of buffer use can be greatly improved, the required buffer memory capacity can be reduced, and costs can be suppressed.

An image formation method of this invention comprises a step of analyzing a document written in a structured tag language and extracting objects forming an image, a step of determining the coordinate position of each object in the image, an object information output step of determining the order when each object is arranged in a prescribed direction, based on the coordinate position of each object, and of outputting information for each object, including coordinate positions, according to the above order, an instruction step of outputting a command specifying a coordinate position and instructing image generation, and an image generation step of partially generating an image up to a coordinate position specified by a command output by the above instruction step based on object information output by the above object information output step; wherein the above instruction step specifies a coordinate position included in object information previously output by the above output step or included in object information which is next output by the above output step, and outputs the above command.

By means of this configuration, the image generation step can partially generate the image, starting with a region up to a coordinate position specified by the instruction command, without waiting to receive the information for all the objects forming the image, so that throughput for image generation can be greatly improved.

It is preferable that the order of arranging when arranging in the above prescribed direction is the order of generation of a printing image, or the order of printing onto printing media.

It is preferable that image generation by the above image generation step comprise generation of a printing image in an image buffer, and/or printing to printing media.

An image formation apparatus of this invention receives object information containing a coordinate position from a layout processing system according to the order of arranging when each object forming an image is arranged in a prescribed direction and generates an image based on this information, wherein partial images are generated, in the order in which object information is received, for a region preceding, in the above prescribed direction, a coordinate position included in the object information.

By means of this configuration, the image formation apparatus can operate as though the content of the image is determined in the region up to the coordinate positions of received object information. As a result, it becomes possible to partially generate the image, starting with a region for which the image content is determined, without waiting for the information for all objects forming the image to be received; as a result, the throughput of image generation can be greatly improved.

Each of the steps of each of the methods of this invention can be caused to be executed on a computer. In this case, the program can be installed or loaded in a computer via a CD-ROM, magnetic disk, semiconductor memory, or various other recording media, or via a communication network.

In this specification, “means” does not merely signify physical means, but also includes cases in which the function of the “means” is realized through software. Also, a function of one “means” may be realized through two or more physical means, and a function of two or more “means” may be realized through one physical means.

Finally, this invention can be applied not only to equipment generally referred to as printers, such as for example inkjet printers or label printers, but also to various other information processing equipment (photocopy equipment, fax equipment, portable communication devices, and similar) comprising functions for formation of images based on documents written using structured tag language.

### DESCRIPTION OF DRAWINGS

FIG. 1 is a block diagram showing the hardware configuration of a printer in one aspect of this invention;

FIG. 2 is a block diagram showing the functional configuration of the information processing portion of a first embodiment;

FIG. 3 is a flowchart showing the operation of an analysis task and a switching control task in the first embodiment;

FIG. 4 is a flowchart showing the operation of a layout task and an object information reception task in the sequential operation of the first embodiment;

FIG. 5 is a flowchart showing the operation of an image generation task and a printing control task in the sequential operation of the first embodiment;

FIG. 6 is a flowchart showing the operation of a layout task and an object information reception task in the parallel operation of the first embodiment;

FIG. 7 is a flowchart showing the operation of the image generation task in the parallel operation of the first embodiment;

FIG. 8 is a figure used to explain a case in which a disagreement occurs between the order of determination of coordinate positions and the order of formation of the image;

FIG. 9 is a figure used to explain a case in which a disagreement occurs between the order of determination of coordinate positions and the order of formation of the image;

FIG. 10 is a figure used to explain the coordinate positions of objects;

FIG. 11 is a figure used to explain the concepts of sequential operation and parallel operation in the first embodiment;

FIG. 12 is a block diagram showing the functional configuration of the information processing portion of a second embodiment;

FIG. 13 is a flowchart showing the operation of the layout system of the second embodiment;

FIG. 14 is a flowchart showing the operation of the object information reception task of the second embodiment;

FIG. 15 is a flowchart showing the operation of the image generation task of the second embodiment;

FIG. 16 is a flowchart showing the operation of the printing control task of the second embodiment; and,

FIG. 17 is a block diagram showing the functional configuration of the information processing portion in a modification of the second embodiment.

### DETAILED DESCRIPTION

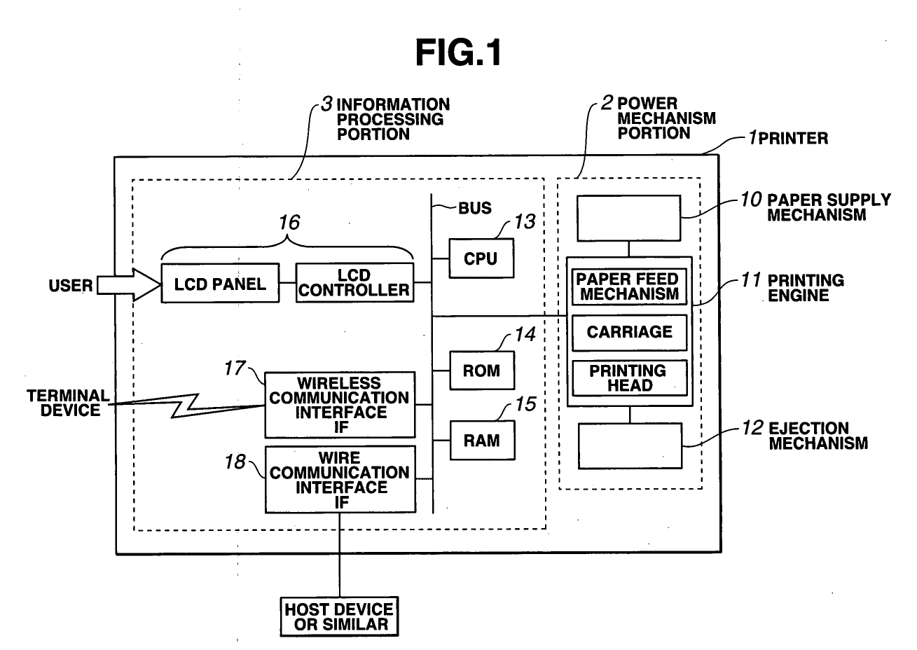

Embodiments of this invention are explained referring to the drawings. FIG. 1 is a block diagram showing the hardware configuration of a printer 1 in an aspect of this invention.

The printer 1 comprises a power mechanism portion 2, in turn comprising a paper supply mechanism 10 to supply paper sheets into the printer, a printing engine 11 to perform printing, and a paper ejection mechanism 12 to eject paper sheets from the printer. The printing engine 11 comprises a paper-feed mechanism, carriage mechanism, and printing head.

As the printing engine 11, a serial printer such as an inkjet printer or thermal transfer printer which prints in one-character units, a line printer which prints in line units, or various other printing engines can be used.

This power mechanism portion 2 is controlled and made to perform printing operations by an information processing portion 3, comprising a CPU (processor) 13, ROM 14, RAM 15, LCD panel and LCD controller 16, wireless communication interface (Bluetooth interface or similar) 17, and wire communication interface 18 (comprising a PC card slot or similar). The CPU 13 can access the several means 14 through 18 via a bus, and controls and causes actual printing to be performed by the power mechanism portion 2 according to a printing job sent or read-out image data, via the wireless communication interface 17 and/or wire communication interface 18, from a digital camera or other terminal device or from a personal computer or other host device (below, the device on the side transmitting the print job is called the “client device”). The power mechanism portion 2 may independently comprise a CPU; in this case, the CPU of the power mechanism portion 2 communicates with the CPU 13 via a parallel interface or similar, and controls and causes printing operation by the printing engine 11.

First Embodiment

In the first embodiment, the configuration and operation of the power mechanism portion 2 and information processing portion 3 are in essence similar to the configuration and operation of printer devices of the prior art. For example, the printer 1 comprises functions to receive a document (including a CSS file or other layout information) written in XHTML or another structured tag language as a printing job, analyze this document and extract objects forming an image, determine the coordinate positions of each object in the image, and execute printing based on object information including coordinate positions.

However, the printer 1 of the first embodiment differs from the conventional configuration in the fact of comprising a function to judge whether the document contains tags (hereafter called “disagreement-inducing tags”) which may cause disagreement between the order of determination of the coordinate positions of objects, and the order of formation of object images. Moreover, the printer 1 also differs from the conventional configuration in the fact of comprising a function which, when it is judged that disagreement-inducing tags are included, performs control such that processing to form the image is executed after the end of processing to determine coordinate positions, and when it is judged that disagreement-inducing tags are not included, performs control such that processing to determine coordinate positions and processing to form images are executed in parallel.

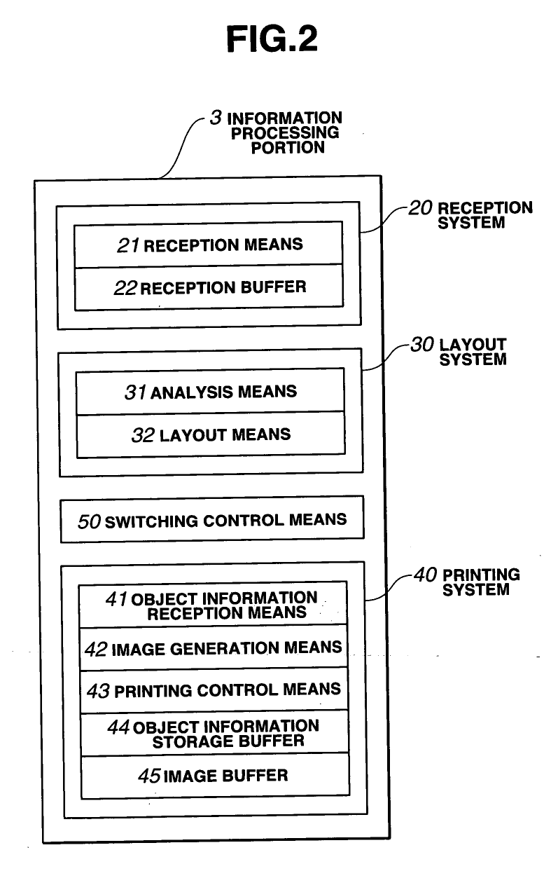

FIG. 2 shows the principal functional configuration in the information processing portion 3 of the first embodiment. As shown in the figure, the information processing portion 3 comprises a receiving system 20, layout system 30, printing system 40, and switching control means 50 and so on. The receiving system 20 comprises reception means 21, a reception buffer 22 and so on; the layout system 30 comprises analysis means 31, layout means 32 and so on; and the printing system 40 comprises object information reception means 41, image generation means 42, printing control means 43, an object information storage buffer 44, an image buffer 45, and so on.

The information processing portion 3 may also comprise, in addition to the above means, image processing (image decompression processing, size conversion processing, noise elimination processing, and so on) means and similar, such as may be comprised by printers in general.

The various means comprised by the information processing portion 3 may be functionally realized through the execution by the CPU 13 of an application program stored in ROM 14 or in RAM 15. It is desirable that the CPU 13 execute the program realizing the various means on a realtime multitasking OS.

The function means realized by executing an application program in this way can be understood as a task (or a process). That is, the reception means, analysis means, layout means, object information reception means, image generation means, printing control means, and switching control means can respectively be understood as a reception task, analysis task, layout task, object information reception task, image generation task, printing control task, and switching control task, executed within the information processing portion 3. Below, wherever there is no particular need to distinguish between “means” and “task”, the term “task” shall be used uniformly.

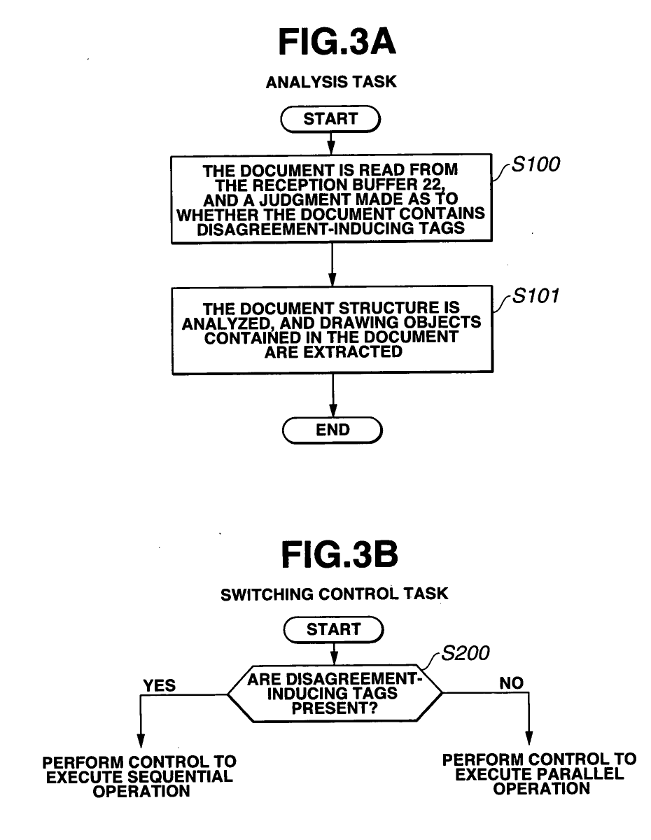

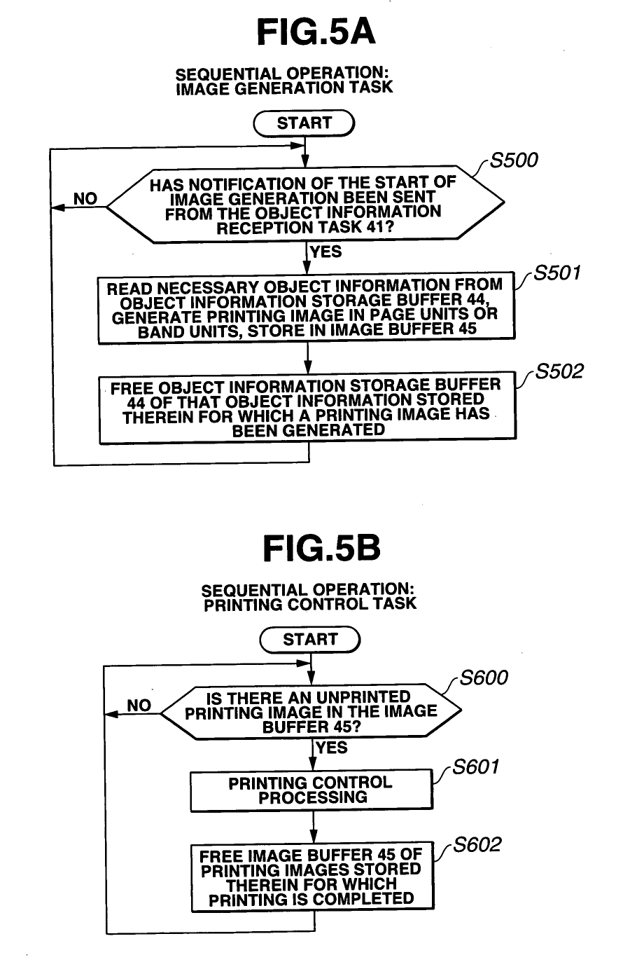

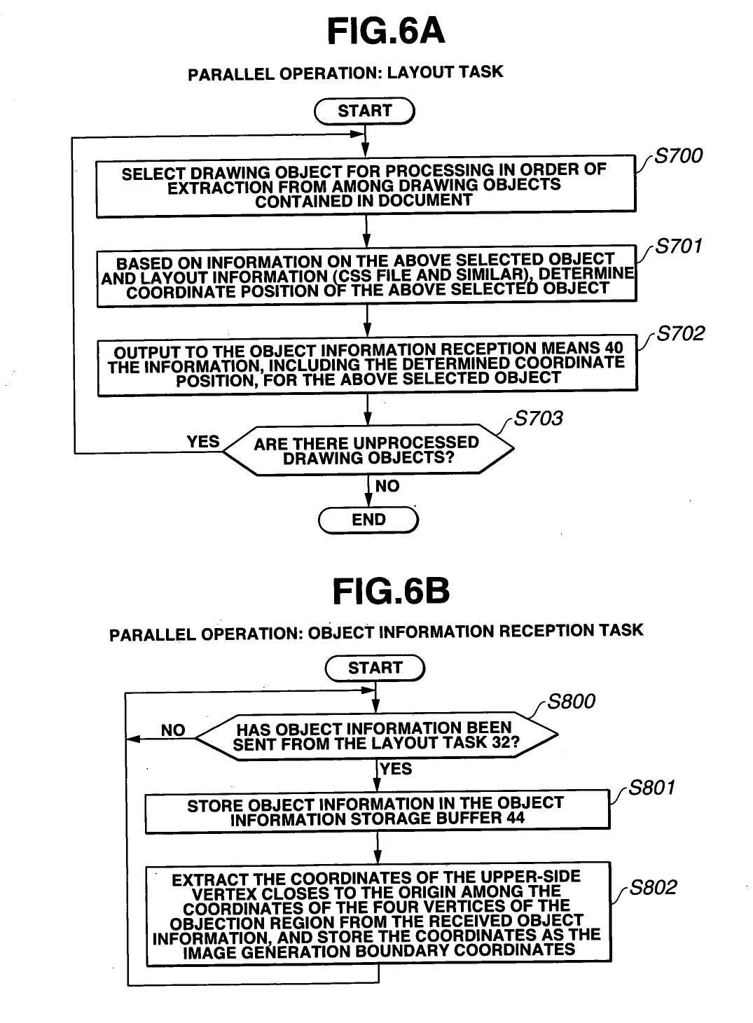

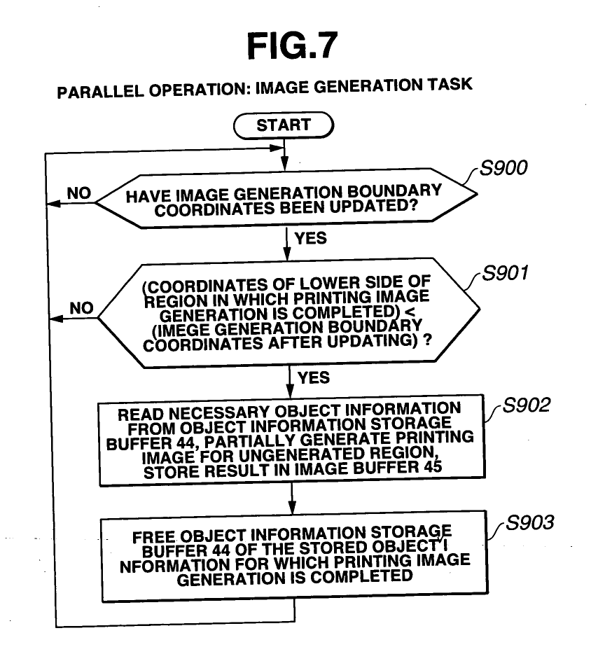

Below, operation of each means is explained, referring to the flowcharts shown in FIG. 3 through FIG. 7. Each step (including partial steps to which a symbol is not assigned) can be executed with the order changed arbitrarily or in parallel, insofar as no contradictions arise in the content of the processing.

The reception task 21 receives a document written in for example XHTML from a terminal device or host device via a network, and stores the document in the reception buffer 22.

The analysis task 31 reads the document from the reception buffer 22, judges whether the entire document contains disagreement-inducing tags, and stores the judgment result (S100).

Here, disagreement-inducing tags can be thought of as, for example, “position”-type tags, “margin”-type tags, “line_height”-type tags, “img”-type tags, and similar. Below, examples are considered to explain cases in which actual disagreements arise due to such tags.

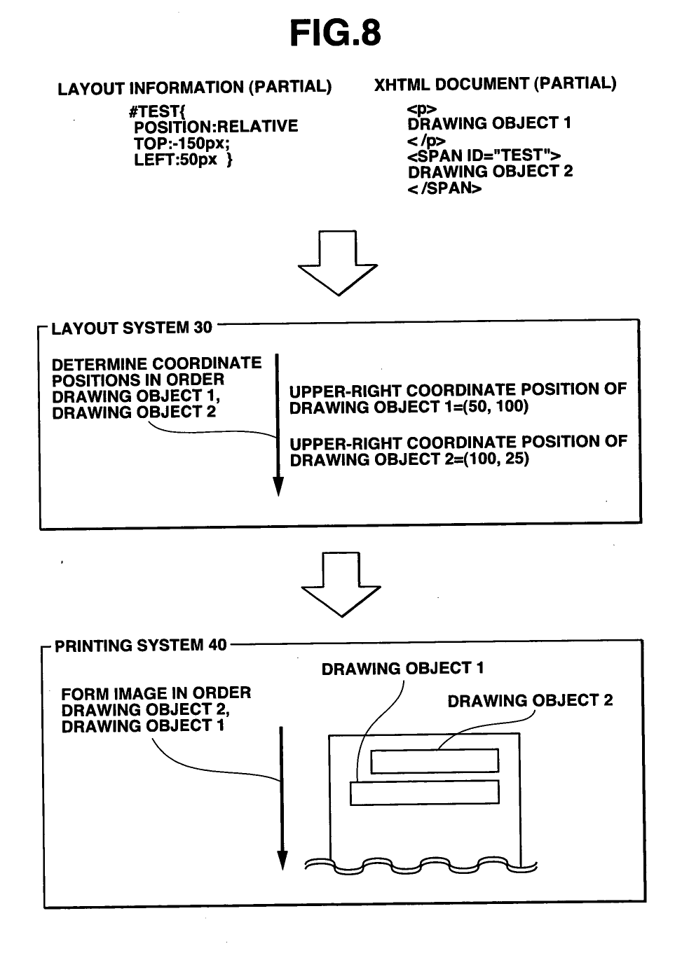

For example, in the case of a document such as that shown in FIG. 8, coordinate positions are determined in the order object 1, object 2 by the layout system 30. On the other hand, as a result of specification by a “position”-type tag, the coordinate position of object 2 is a position at which the image is formed (printed) before object 1, so that the printing system 40 forms the images in the order object 2, object 1. Consequently disagreement arises between the order of determination of coordinate positions and the order of image formation.

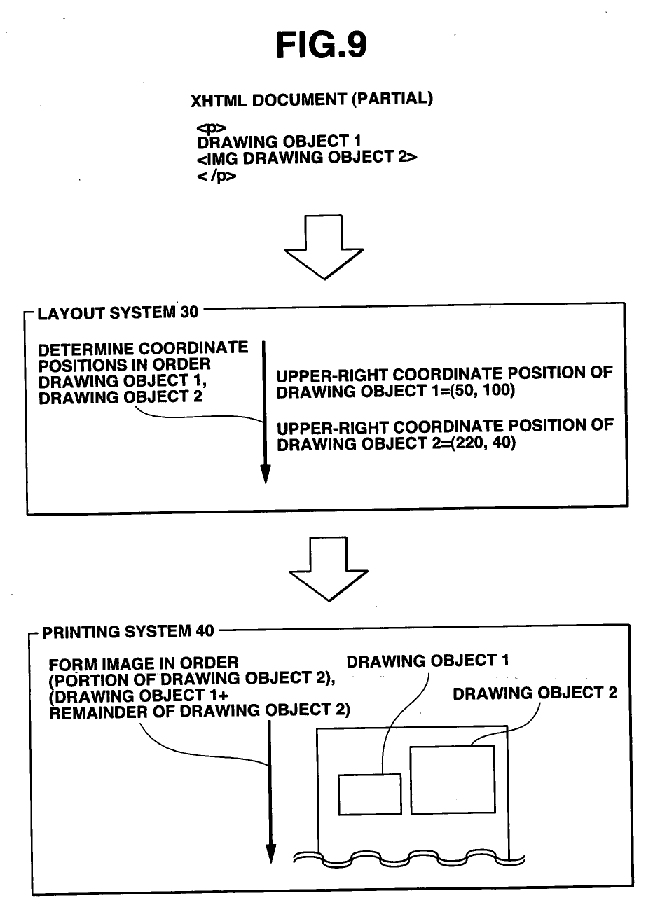

Similarly, as for example in the case of a document such as that shown in FIG. 9, the layout system 30 determines coordinate positions in the order object 1, object 2. On the other hand, object 2 is an image object specified by an “img”-type tag, and in this example the image size is large, so that the printing system 40 forms images in the order (a portion of object 2), (object 1+the remainder of object 2). Consequently disagreement arises between the order of determination of the coordinate positions and the order of image formation.

In this way, in cases where there are “position”-type tags, “margin”-type tags, “line_height”-type tags, or other tags which specify, directly or indirectly, the coordinate position of an object, and in cases where there are a plurality of objects in a paragraph at least one of which is an image object (cases in which an “img”-type tag is contained in a paragraph), the possibility arises that disagreement may occur between the order of determination of coordinate positions and the order of image formation.

Next, the analysis task 31 analyzes the structure of the document, and extracts objects contained in the document (S101). This step can be configured similarly to that comprised by conventional printers supporting XHTML.

Next, determination of coordinate positions by the layout task 32, and image formation and printing by the printing system 40, are executed.

As explained above, in cases where there is the possibility of disagreement between the order of determination of coordinate positions and the order of image formation, the printing system 40 cannot execute image formation and similar until after coordinate positions have been acquired for all objects in the document, that is, can only execute image generation and similar in a sequential mode with respect to the layout task 32.

On the other hand, when there is no possibility of disagreement in order, the printing system 40 can operate as though the content of the image is determined in the region up to the coordinate position of the received object information, that is, as though the image content is not affected by (does not overlap with) object information to be received subsequently. As a result, in the printing system 40, it is possible to partially generate the printing image starting with a region the image content of which has been determined, and to partially print onto printing media starting with this generated partial printing image, without waiting for the reception of all object information, that is, in a parallel mode with respect to the layout task 32.

In this aspect, a configuration is adopted in which the operation mode of the layout task 32 and printing system 40 is switched, by the switching control task 50, based on whether there is the possibility of order disagreement (the judgment result of the analysis task 31).

Specifically, based on the judgment result of the analysis task 31, the switching control task 50 performs control such that the sequential operation explained below is executed when a disagreement-inducing tag is included in the document, and such that the parallel operation explained thereafter is executed when no disagreement-inducing tags are included therein (S200).

Sequential Operation

Based on the information on the extracted objects and the layout information (CSS file and similar), the layout task 32 determines the coordinate positions of all objects contained in the document (S300). The step of determining coordinate positions can be configured similarly to the task comprised by a conventional printer supporting XHTML.

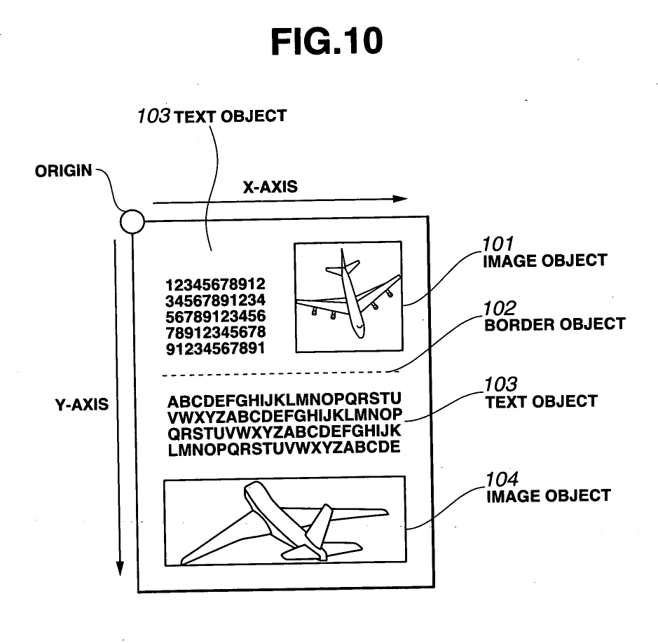

As shown in FIG. 10, the coordinate position of an object can be specified as the coordinates of the minimum rectangular region encompassing the object, when the origin is taken at the upper-left of the image (the scan starting position), the right-hand direction (principal scan direction) is the +X direction, and the downward direction (the sub-scan direction, or paper feed direction) is the +Y direction when printing.

Next, the layout task 32 outputs information for each object, including coordinate positions thus determined, to the object information reception means 40 (S301). The output timing may be such that output is performed each time a coordinate position is determined, or may be such that output is performed all at once after deciding the coordinate positions of all objects.

In the case of a text object, the object information may be configured to include drawing commands, font information (font type, size, color, and similar), character codes, object coordinate positions, and other information. In the case of an image object, the object information may be configured to include drawing commands, the image storage location, the image output size, the object coordinate position, and other information. In the case of a border object, the object information may be configured to include drawing commands, line types (solid lines, dashed lines, and similar), colors, thicknesses, the object coordinate position, and other information.

The object information reception task 41 monitors the sending of object information from the layout task 32 (S400), and when information is sent, stores the information in the object information storage buffer 44 (S401).

Next, the object information reception task 41 judges whether all object information has been received (S402), and if received, notifies the image generation task 42 of the start of image generation and returns to S400 (S403), and otherwise returns to S400 without further action.

Upon notification of the start of image generation by the object information reception task 41, the image generation task 42 proceeds to S501 (S500).

The image generation task 42 reads the necessary object information from the object information storage buffer 44, generates a printing image in page units or in band units, and stores the result in the image buffer 45 (S501). Here, a “page” is a unit of image generation (printing unit), and if for example printing onto paper, is equivalent to the image to be printed on one page of paper.

Next, the image generation task 42 frees the buffer of those objects stored in the object information storage buffer 44 for which printing image generation has ended, and returns to S500 (S502).

The printing control task 43 judges whether an unprinted printing image is in the image buffer 45, and if there is, proceeds to S601 (S600).

The printing control task 43 executes printing control processing (S601). For example, prescribed instructions (printing requests, paper feed requests, paper supply/ejection requests, and similar) are output to the printing engine 11 and so on, and an unprinted printing image is transferred to the printing engine 11 from the image buffer 45, and printing onto paper or other recording media is executed while controlling the printing engine 11.

Next, the printing control task 43 frees from the image buffer 45 the printing images stored in the image buffer 45 printing of which has ended, and then returns to S600 (S602).

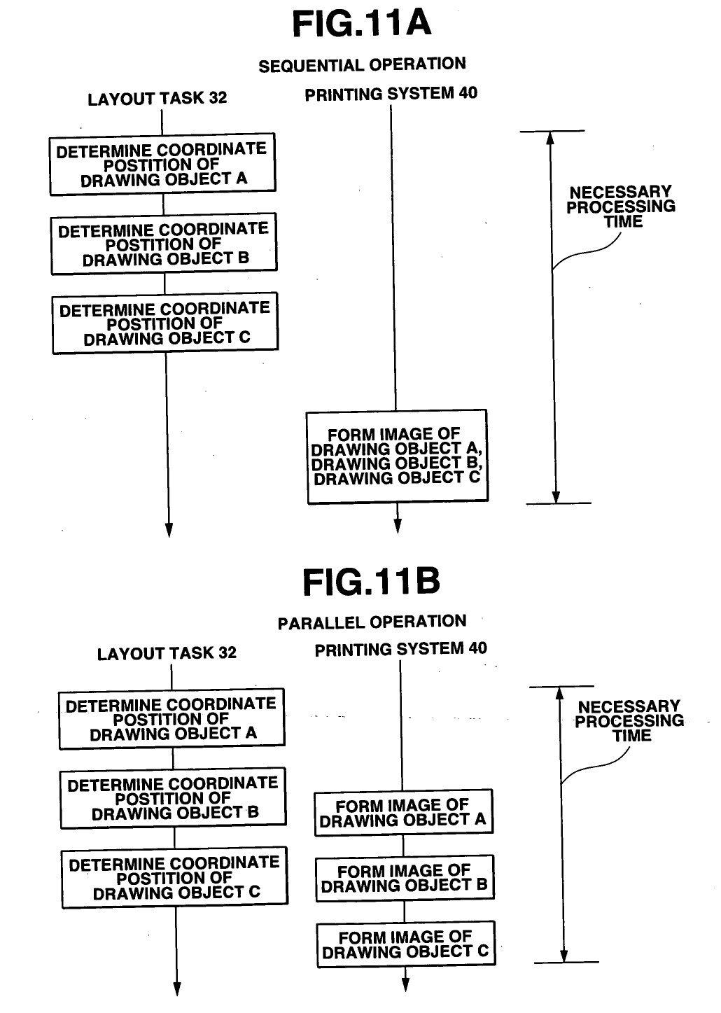

In FIG. 11A, conceptually illustrates the sequential operation. As is seen from the figure, in the case of sequential operation, after the end of processing to determine coordinate positions by the layout task 32, the printing system 40 (image generation task 42, printing control task 43) acquires the coordinate positions for all objects, and executes image generation and printing.

Parallel Operation

The layout task 32 selects, from among the objects contained in the document, an object to be processed, in the order of extraction (S700).

Next, the layout task 32 determines the coordinate position of the above selected object, based on the information for the above selected object and layout information (a CSS file or similar) (S701).

Next, the layout task 32 outputs to the object information reception means 40 the information for the above selected object, including the determined coordinate position (S702).

The layout task 32 repeatedly executes the above processing until there are no more objects for processing (S703).

The object information reception task 41 monitors the sending of object information from the object information output task 33 (S800), and when sent, stores the information in the object information storage buffer 44 (S801).

Next, the object information reception task 41 extracts the coordinates of the upper vertex closest to the origin (the upper-left vertex coordinates or upper-right vertex coordinates) among the coordinates of the four vertices of the object region from the received object information, stores these coordinates as the image generation boundary coordinates, and returns to S800 (S802).

The image generation task 42 monitors updating of the above image generation boundary coordinates, and when updated, proceeds to S901 (S900).

The image generation task 42 judges whether the condition (coordinates of lower side of region in which printing image generation is completed)<(image generation boundary coordinates after updating) obtains (S901), that is, whether, in the region preceding the image generation boundary coordinates in the downward direction after updating, there is still a region in which the printing image has not yet been generated (an ungenerated region), and if this condition obtains (there is an ungenerated region), proceeds to S902.

The image generation task 42 reads the necessary object information from the object information storage buffer 44, partially generates a printing image for an ungenerated region, and stores the image in the image buffer 45 (S902).

Next, the image generation task 42 frees the object information storage buffer 44 of the object information stored in the buffer for which generation of a printing image has ended, and returns to S900 (S903).

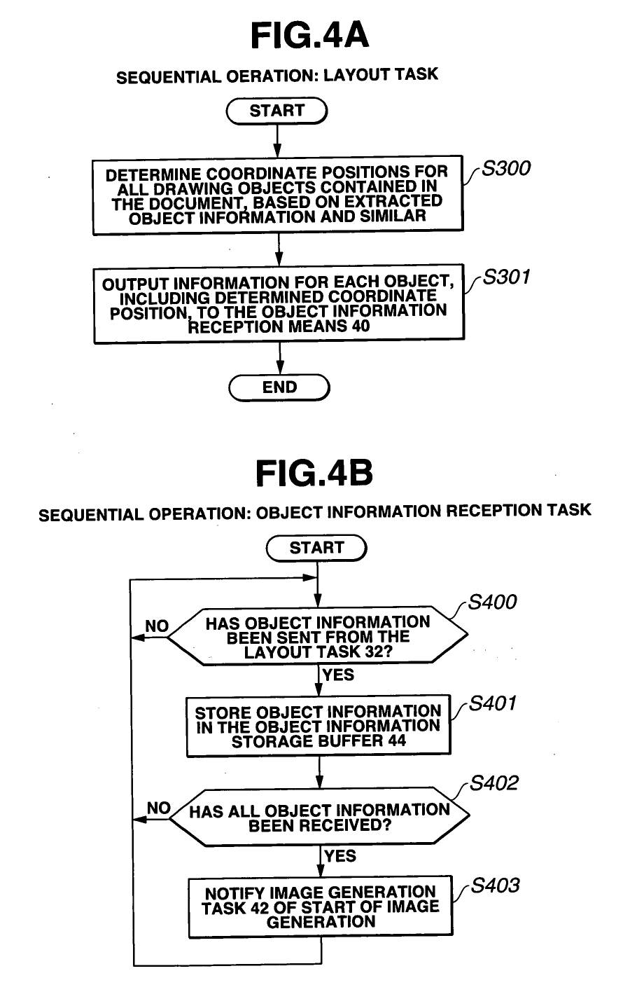

The operation of the printing control task 43 is similar to the case of sequential operation in FIG. 4, and so an explanation is here omitted.

A conceptual drawing of parallel operation is shown in FIG. 11B. As is seen from the figure, in the case of parallel operation the printing system 40 (image generation task 42, printing control task 43) can operate without waiting for reception of all object information from the layout task 32, that is, in parallel with the layout task 32.

As explained above, in this aspect a configuration is employed in which there is switching between sequential operation and parallel operation based on the presence or absence of disagreement[-inducing] tags; consequently the processing time is shortened when no disagreement-inducing tags are contained in the document, and so the throughput of printing and similar can be greatly improved.

Modification Example

This invention is not limited to the first embodiment, and various modifications are possible.

For example, in the above first embodiment, a configuration is employed in which the presence or absence of disagreement-inducing tags is judged in the analysis task 31, but a configuration may be employed in which a preprocessing system is provided which is executed in advance of the layout system 30, and in which the presence or absence of disagreement-inducing tags is judged in this preprocessing system.

Or, for example, a configuration may be employed in which switching between sequential operation and parallel operation is controlled based on the presence or absence of tags which impede the execution of processing to form images based on object coordinate positions in parallel with processing to determine object coordinate positions, in place of or in addition to disagreement-inducing tags. In this case also, the throughput of printing or other operations can be greatly improved.

Tags which may impede parallel execution may include, in addition to the “position”-type tags, “margin”-type tags, “line_height”-type tags, and “img”-type tags and similar considered as examples in the above aspect, “counter”-type tags or similar. For example, in a case in which a document is configured so as to display the text “(page number/total number of pages)” using a “counter”-type tag, if the layout for the entire document is not first determined and the total number of pages ascertained, the contents of the “(page number/total number of pages)” text cannot be determined, and so the layout task 32 and the printing system 40 cannot be operated in parallel.

Or for example, in the above first embodiment, a configuration is employed in which, in document units, the presence or absence of disagreement-inducing tags is judged and switching between sequential operation and parallel operation is controlled; but this invention is not limited to such a configuration. For example, a configuration may be employed in which, according to the tag type, the above judgment and the above control are performed for the entire document or to a portion thereof, or preferably for the range which is affected by the tag (for example, the entire document, a single page (a range demarcated by page breaks), a paragraph, or similar). For example, the presence or absence of tags which affect the entire document (document-affecting tags) is judged for the entire document, whereas the presence or absence of tags which affect paragraph units (paragraph-affecting tabs) is judged for each paragraph. In this case, switching control based on the presence or absence of a paragraph-affecting tag is valid only in cases in which a document-affecting tag is not included (in other words, when a document-affecting tag is included, sequential operation is performed for the entire document, regardless of the presence or absence of paragraph-affecting tags). By means of this configuration, the possibility of parallel operation can be judged for each prescribed range according to the tag type, and so processing can be switched more precisely and flexibly when performing operations.

Also, in the parallel operation of the above first embodiment, for example, a configuration is employed in which each time the condition (coordinates of lower side of region in which printing image generation is completed)<(image generation boundary coordinates after updating) obtains, that is, each time a region occurs in which a printing image has not been generated, the image generation task 42 generates a partial printing image; but this invention is not limited to such a configuration. For example, a configuration may be employed in which a printing image is partially generated when the condition (image generation boundary coordinates after updating)−(coordinates of lower side of region in which printing image generation is completed)>(threshold value) obtains, that is, when the region in which a printing image has not been generated is larger than a constant value.

Second Embodiment

In a second embodiment, the configuration and operation of the power mechanism portion 2 and information processing portion 3 are in essence the same as the configuration and operation in a conventional printer device. For example, this printer 1 comprises functions to receive, as a printing job, a document (including a CSS file) written in XHTML or another structured tag language (reception task), analyze this document and extract objects forming an image (analysis task), determine the coordinate positions in the image of each object (layout task), and execute printing based on object information including coordinate positions (printing task).

However, the layout task of the printer 1 in the second embodiment differs from the conventional configuration in the fact of comprising a function in which, after object coordinate positions have been determined, the order when objects are arranged in a prescribed direction (for example, in the sub-scanning direction when printing) based on the coordinate positions of each object, and information for each object, including coordinate positions, is output to the printing task according to this order.

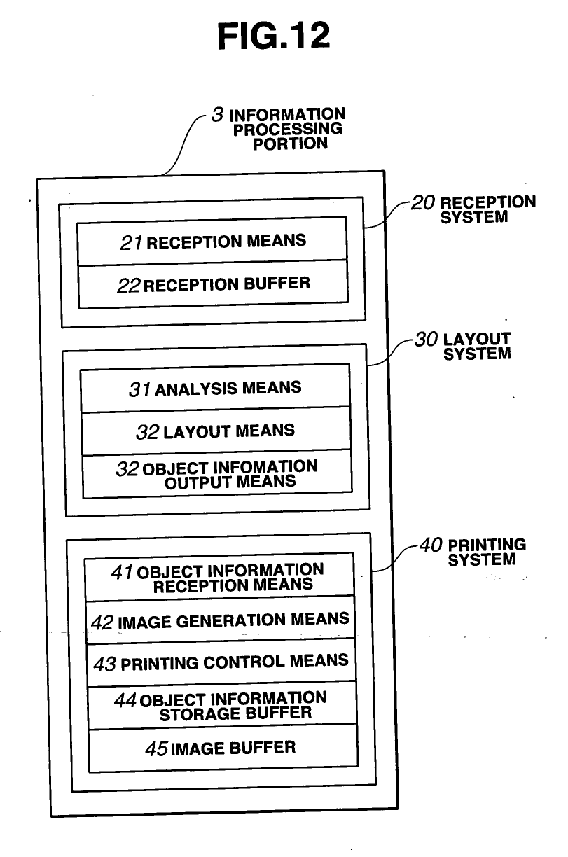

FIG. 12 shows the configuration of principal functions in the information processing portion 3 of the second embodiment. As shown in the figure, the information processing portion 3 comprises a reception system 20, layout system 30, and printing system 40. The reception system 20 comprises reception means 21, a reception buffer 22 and so on; the layout system 30 comprises analysis means 31, layout means 32, object information output means 33 and so on; and the printing system 40 comprises object information reception means 41, image generation means 42, printing control means 43, an object information storage buffer 44, an image buffer 45 and so on.

The information processing portion 3 may also comprise, in addition to the above means, means for image processing (image decompression processing, size conversion processing, noise elimination processing, and similar) and similar, such as may be comprised by printers in general.

The various means comprised by the information processing portion 3 are functionally realized through the execution by the CPU 13 of an application program stored in ROM 14 or in RAM 15. It is desirable that the CPU 13 execute the program realizing the various means on a realtime multitasking OS.

The function means realized by executing an application program in this way can, similarly to the first embodiment, be understood as a task (or a process). That is, the reception means, analysis means, layout means, object information output means, object information reception means, image generation means, and printing control means can respectively be understood as a reception task, analysis task, layout task, object information output task, object information reception task, image generation task, and printing control task, executed within the information processing portion 3. Below, also in the second embodiment, wherever there is no particular need to distinguish between “means” and “task”, the term “task” shall be used uniformly.

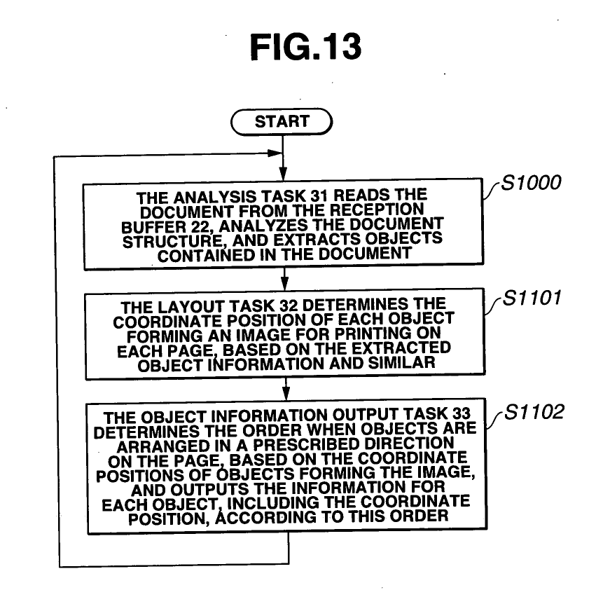

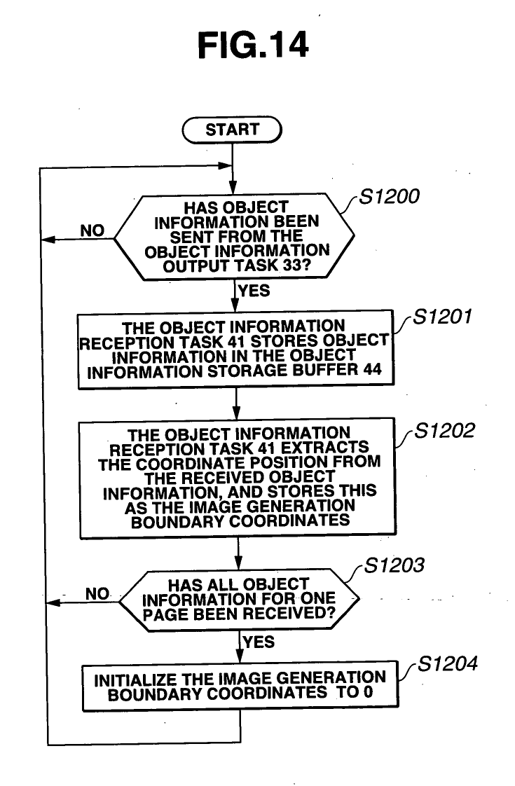

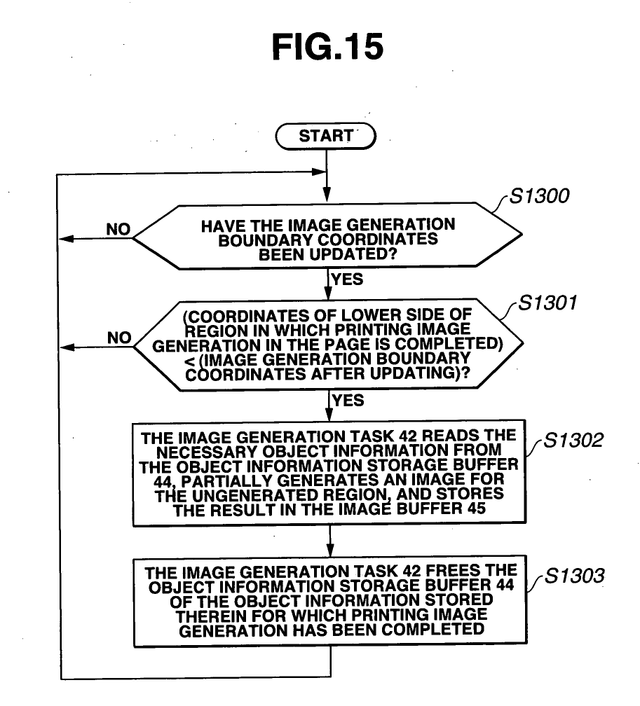

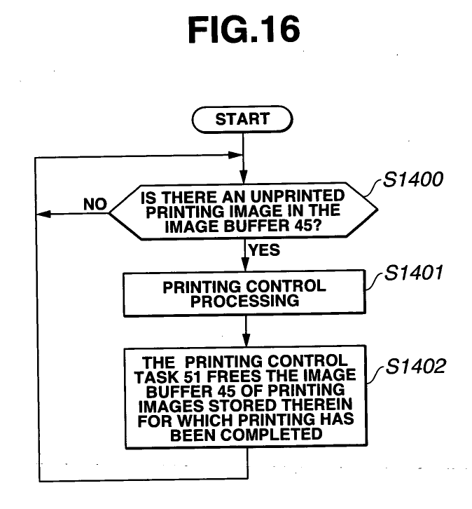

Below, operation of each means is explained, referring to the flowcharts shown in FIG. 13 through FIG. 16. Each step (including partial steps to which a symbol is not assigned) can be executed with the order changed arbitrarily or in parallel, insofar as no contradictions arise in the content of the processing.

The reception task 21 receives a document written in for example XHTML from a client device over a network, and stores the document in the reception buffer 22.

The analysis task 31 reads the document from the reception buffer 22, analyzes the document structure, and extracts objects (text, images, borders and similar) contained in the document (S1000). The analysis task 31 can employ a configuration similar to that comprised by conventional printers supporting XHTML.

The layout task 32 determines the coordinate position of each object forming the image for printing on each page, based on the extracted object information and layout information (a CSS file and similar) (S1101).

Here, a “page” is a unit of image generation (printing unit), and if for example printing onto paper, is equivalent to the image to be printed on one page of paper.

As shown in FIG. 10, similarly to the first embodiment, the coordinate position of an object can be specified as the coordinates of the minimum rectangular region encompassing the object, when the origin is taken at the upper-left of the image (the scan starting position), the right-hand direction (principal scan direction) is the +X direction, and the downward direction (the sub-scan direction, or paper feed direction) is the +Y direction when printing.

The layout task 32 can be configured similarly to the function comprised by a conventional printer supporting XHTML.

The object information output task 33 determines the order when arranging objects in a prescribed direction on each page, based on the coordinate positions of each object forming the image, and outputs the information for each object, including coordinate positions, to the object information reception task 41 according to this order (S1102).

Here the order when arranging in the above prescribed direction is the order of generating of the printing image in the printing system 40, or the order of printing onto paper or other recording media in the printing engine 11. Hence in general the above prescribed direction is the downward direction (sub-scanning direction), and the order when arranging objects in the downward direction is the order when arranging in ascending order in the downward direction relative to the coordinates of the upper-side vertex closest to the origin (the upper-left coordinates or upper-right coordinates) among the coordinates of the four vertices of the object. For example, in the example shown in FIG. 10, the order when the text object 100, image object 101, border object 102, text object 103, and image object 104 are arranged in the downward direction is 101, 100, 102, 103, 104.

As the algorithm to determine the order, various well-known sorting algorithms can be used. However, it is sufficient that processing be performed to determine the order, and it is not necessary that actual arrangement in that order be performed.

The object information output by the object information output task 33 includes, in the case of a text object, drawing commands, font information (font type, size, color, and similar), character codes, the object coordinate position, and other information. In the case of an image object, the object information includes drawing commands, the image storage location, the image output size, the object coordinate position, and other information. In the case of a border object, the information includes drawing commands, line types (solid lines, dashed lines, and similar), colors, thicknesses, the object coordinate position, and other information.

The object information reception task 41 monitors the sending of object information from the object information output task 33 (S1200), and when sent, stores the information in the object information storage buffer 44 (S1201).

Next, the object information reception task 41 extracts the coordinate position (coordinates on the basis of which the output order is determined) from the received object information, and stores this position as the image generation boundary coordinates (S1202).

Next, the object information reception task 41 judges whether one page's worth of object information has been received (S1203), and if received, initializes the image generation boundary coordinates to 0 and returns to S1200 (S1204), and if not received, returns without further action to S1200.

The image generation task 42 monitors the updating of the above image generation boundary coordinates, and when updated, proceeds to S1301 (S1300).

The image generation task 42 judges whether the condition (coordinates of lower side of region in which printing image generation in the page is completed)<(image generation boundary coordinates after updating) obtains (S1301), that is, whether, in the region preceding the image generation boundary coordinates in the downward direction after updating, there is still a region in which the printing image has not yet been generated (an ungenerated region), and if this condition obtains (there is an ungenerated region), proceeds to S1302.

The image generation task 42 reads the necessary object information from the object information storage buffer 44, partially generates a printing image for an ungenerated region, and stores the image in the image buffer 45 (S1302).

Next, the image generation task 42 frees the object information storage buffer 44 of the object information stored in the buffer for which generation of a printing image has ended, and returns to S1300 (S1303).

The printing control task 51 judges whether there is a printing image which has not yet been printed in the image buffer 45, and if there is such an image, proceeds to S1401 (S1400).

The printing control task 51 executes printing control processing (S1401). For example, a prescribed instruction (a printing request, paper feed request, paper supply/ejection request, or similar) is output to the printing engine 11 and so on, the printing image which has not yet been printed is transferred from the image buffer 45 to the printing engine 11, and printing to paper or other recording media is executed while controlling the printing engine 11 (S1401).

Next, the printing control task 51 frees the image buffer 45 of those printing images stored in the buffer for which printing has ended, and returns to S1400 (S1402).

Thus in this aspect, a configuration is adopted in which the layout system 30 passes object information to the printing system 40 according to the order in which printing images are generated in the printing system 40 or the order in which printing onto paper or other recording media is performed in the printing image 11, based on the coordinate positions for each object, so that the printing system 40 can operate as though the content of the image in the region up to the coordinate positions of the information for the received objects (coordinates on the basis of which the output order is determined) has been determined, that is, as if the content of the image is not affected by (does not overlap with) object information to be received thereafter. As a result, in the printing system 40, it is possible to partially generate the printing image starting with a region the image content of which has been determined, and to partially print onto printing media starting with this generated partial printing image, without waiting for the reception of all object information within the page, so that the throughput for printing or other operations can be greatly improved.

Further, because printing images can be partially generated or printed to printing media within a page, the object information used in generation and the printing image itself can be managed in units of partial generation rather than in page units. Consequently the efficiency of buffer use can be greatly improved, the memory capacity required for the buffer can be reduced, and costs can be suppressed.

Modification Example

This invention is not limited to the above second embodiment, and various modifications are possible.

For example, in the above second embodiment, a configuration is employed in which the printing task automatically generates partial images, but instead of this configuration, a configuration may be employed in which instructions to generate partial images are received by the printing task, and partial images are generated according to these instructions.

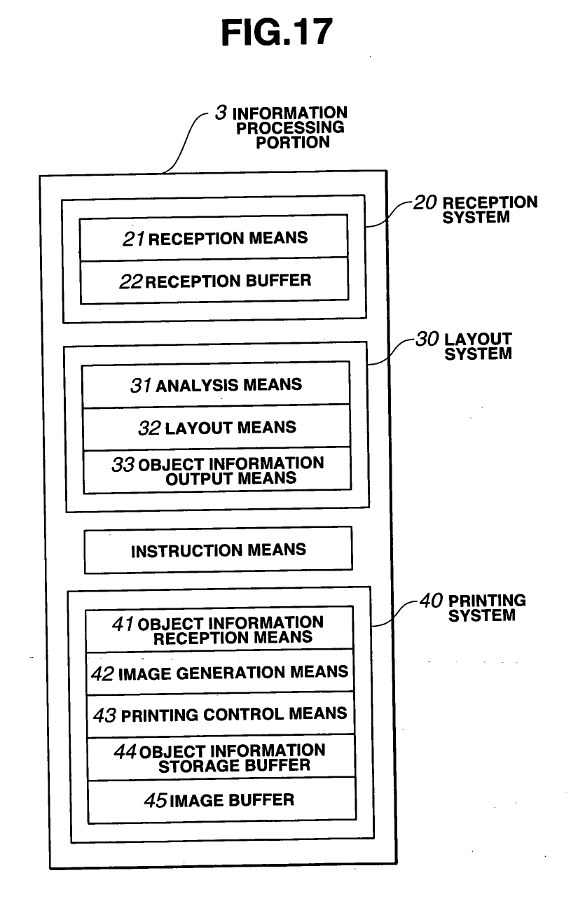

In this case, the printer 1 comprises an instruction task (instruction means) which outputs commands to the printing task instructing image generation. A configuration may be employed in which this instruction task is also performed by the object information output task 33, for example, or a configuration may be employed in which the task is provided separately from the layout system 20, as shown in FIG. 17.

The instruction task specifies object a coordinate position (coordinates on the basis of which the output order is determined) contained in the object information previously output by the object information output task 33, or in the object information to be output next, and outputs an instruction command. For example, when the object information output task 33 outputs object information in order for objects A, B and C, the instruction task can specify the coordinate position of object A or object B in the interval between output of information for A and B, and can specify the coordinate position of object A, B or C in the interval between output of information for B and C, to output an instruction command. However, in order to further improve the throughput for printing or other operations, it is preferable that the coordinate position contained in the object information to be output next be specified (in the interval between output of information for A and B, specifying the coordinate position for object B, and in the interval between output of information for B and C, specifying the coordinate position for object C), in order that partial image generation can be performed earlier.

When an instruction task is provided as described above, the step of S1201 (the step of extracting coordinate positions from received object information and storing the positions as image generation boundary coordinates) by the object information reception task 41 is no longer necessary. Also, the image generation task 42, instead of monitoring updates of the image generation boundary coordinates, reads the necessary object information from the object information storage buffer 44 when an instruction command is received from the instruction task, and performs processing to partially generate an image up to the coordinate position specified by the instruction command within the region in which an image has not yet been generated.

When employing such a configuration, similarly to the above-described second embodiment, in the printing system 40 a printing image can be partially generated starting with the region up to the coordinate position specified by the instruction command, without waiting for reception of all object information on the page, and partial printing to recording media can be performed starting with the generated printing image, so that the throughput of printing or other operations is improved, the efficiency of buffer use is improved, the memory capacity required for the buffer is reduced, and costs can be suppressed.

Also, in the above second embodiment a configuration is employed in which the image generation task 42 partially generates a printing image each time the condition (coordinates of lower side of region in which printing image generation in the page is completed)<(image generation boundary coordinates after updating) obtains, that is, each time a region in which a printing image has not been generated occurs; but the present invention is not limited to such a configuration. For example, a configuration may be employed in which a printing image is partially generated when the condition (image generation boundary coordinates after updating)−(coordinates of lower side of region in which printing image generation in the page is completed)>(threshold value) obtains, that is, when the region in which a printing image has not been generated is larger than a constant value.

Further, in the above second embodiment a configuration is employed in which determination of the coordinate positions of the various objects forming an image is performed for each page, but this invention is not limited to such a configuration. For example, a configuration may be employed in which operations are performed over the range of a portion of a page, or over a range of one or more pages.

The entire disclosure of Japanese Patent Application No. 2002-363069, filed on Dec. 13, 2002, including the specification, claims, drawings and summary, are incorporated herein by reference in its entirety.

We claim:

1. A control method relating to image formation, comprising the steps of:
judging whether a document written in a structured tag language comprises tags which can cause disagreement between the order in which the coordinate positions of objects are determined and the order in which the images of objects are formed;
performing control, when said tags are judged to be comprised, such that processing to form images is executed after the end of processing to determine coordinate positions; and
performing control, when said tags are judged not to be comprised, such that processing to determine coordinate positions and processing to form images are executed in parallel.

2. A control method relating to image formation, comprising the steps of:
judging whether a document written in a structured tag language comprises tags which can impede the parallel execution of processing to determine the coordinate positions of objects and processing to form the images of objects;
performing control, when said tags are judged to be comprised, such that processing to form images is executed after the end of processing to determine coordinate positions; and
performing control, when said tags are judged not to be comprised, such that processing to determine coordinate positions and processing to form images are executed in parallel.

3. The control method relating to image formation according to claim 1 or claim 2, wherein said judgment and said control are performed for the entire document or for a portion thereof according to the type of said tags.

4. The control method relating to image formation according to claim 1 or claim 2, wherein said tags comprise at least one among “position”-type tags, “margin”-type tags, “line_height”-type tags, “img”-type tags, and “counter”-type tags.

5. A control apparatus relating to image formation, comprising:
judgment means for judging whether a document written in a structured tag language comprises tags which can cause disagreement between the order in which the coordinate positions of objects are determined and the order in which the images of objects are formed; and
control means which, when said tags are judged to be comprised, performs control such that processing to form images is executed after the end of processing to determine coordinate positions, and, when said tags are judged not to be comprised, performs control such that processing to determine coordinate positions and processing to form images are executed in parallel.

6. A control apparatus relating to image formation, comprising:
judgment means for judging whether a document written in a structured tag language comprises tags which can impede the parallel execution of processing to determine the coordinate positions of objects and processing to form the images of objects; and
control means which, when said tags are judged to be comprised, performs control such that processing to form images is executed after the end of processing to determine coordinate positions, and, when said tags are judged not to be comprised, performs control such that processing to determine coordinate positions and processing to form images are executed in parallel.

7. A layout processing method, comprising:
a step of analyzing a document written in a structured tag language and extracting objects forming an image;
a step of determining the coordinate position of each object in the image; and
an object information output step of determining the order when each object is arranged in a prescribed direction, based on the coordinate position of each object, and of outputting information for each object, comprising the coordinate position, according to said order.

8. An image formation method, comprising:
a step of analyzing a document written in a structured tag language, and of extracting objects forming an image;
a step of determining the coordinate position of each object in the image;
an object information output step of determining the order when each object is arranged in a prescribed direction, based on the coordinate position of each object, and of outputting information for each object, comprising the coordinate position, according to said order; and
an image generation step of generating an image based on the object information output by said object information output step,
wherein said image generation step generates, in the order of reception of object information, a partial image for a region preceding, in said prescribed direction, the coordinate position included in the object information.

9. An image formation method, comprising:
a step of analyzing a document written in a structured tag language, and of extracting objects forming an image;
a step of determining the coordinate position of each object in the image;
an object information output step of determining the order when each object is arranged in a prescribed direction, based on the coordinate position of each object, and of outputting information for each object, comprising the coordinate position, according to said order;
an instruction step of outputting a command specifying a coordinate position and instructing image generation; and
an image generation step of generating, based on object information output by said object information output step, a partial image up to a coordinate position specified by a command output by said instruction step,
wherein said instruction step specifies a coordinate position included in the object information previously output by said output step or included in the object information to be output next by said output step, to output said command.

10. The image formation method according to claim 8 or claim 9, wherein the order when arranging in said prescribed direction is the order of generation of a printing image, or the order of printing onto recording media.

11. The image formation method according to claim 8 or claim 9, wherein generation of a image by said image generation step comprises generation of a printing image in an image buffer, and/or printing onto recording media.

12. A layout processing apparatus, comprising:
means for analyzing a document written in a structured tag language, and of extracting objects forming an image;
means for determining the coordinate position of each object in the image; and
object information output means for determining the order when arranging each object in a prescribed direction, based on the coordinate position of each object, and of outputting information for each object, comprising the coordinate position, according to said order.

13. An image formation apparatus, which, for each object forming an image, receives from a layout processing system object information comprising a coordinate position according to the order when arranging each object in a prescribed direction, and generates an image based on said information,
wherein partial images are generated, in the order of reception of object information, for a region preceding, in said prescribed direction, a coordinate position included in the object information.
